(19) United States
(12) Patent Application Publication
(10) Pub. No.: US 2002/0176324 A1
(43) Pub. Date: Nov. 28, 2002

(54) Digital broadcast receiver

(76) Inventor: Kazuhide Ishihara, Osaka (JP)

Correspondence Address: ROSENTHAL & OSHA L.L.P., 1221 MCKINNEY AVENUE, SUITE 2800, HOUSTON, TX, 77010, US

(21) Appl. No.: 10/152,927

(22) Filed: May 22, 2002

(30) Foreign Application Priority Data
May 28, 2001 (JP) P.2001-159295

(51) Int. Cl. G04C 11/02

(52) U.S. Cl. 368/47

(57) ABSTRACT

In a digital broadcast receiver, a digital broadcast receiver 10 can receive a digital broadcast signal having data of universal standard time and an intrinsic ID number of a broadcast station, and comprises a clock 26, ROM 18 for storing the intrinsic ID number of the broadcast station and data of a time zone of the broadcast station, and an MPU 27 for controlling the clock 26 and the ROM 18, and the MPU 27 reads data of a time zone of the broadcast station corresponding to the intrinsic ID number of the broadcast station receiving at the most ratio out of the ROM 18 and adds the data of the universal standard time to the data of the time zone to calculate time of a place where the broadcast station receiving most is located and adjusts time of the clock 26 to this calculated time.

### BACKGROUND OF THE INVENTION

1. Field of the Invention

The present invention relates to a digital broadcast receiver, and particularly to a digital broadcast receiver capable of receiving a digital broadcast signal having data of universal standard time and an intrinsic ID number of a broadcast station.

2. Description of the Related Art

Conventionally, a method for automatically adjusting time of a clock built into equipment has been proposed. For example, a portable receiver which is a portable receiver for receiving a signal indicating position information and determines a time zone corresponding to a position and adjusts a built-in clock in response to the time zone is disclosed in JP-W-4-504941.

However, the portable receiver described in JP-W-4-504941 adjusts time of the clock from time of the determined time zone and time presently shown by the clock, so that a user must preset the present time. Therefore, when the time preset by the user is incorrect, the time of the clock adjusted with a change in the time zone also remains incorrect.

Also, data of universal standard time and an intrinsic ID number of a broadcast station are included in a digital broadcast signal for digital television, but there is no apparatus for using their data in time adjustment of a clock built into a digital broadcast receiver.

### SUMMARY OF THE INVENTION

In view of the problem, an object of the invention is to provide a digital broadcast receiver capable of automatically adjusting time of a built-in clock using a received digital broadcast signal.

In order to achieve the object, a digital broadcast receiver according to the invention is characterized in that in a digital broadcast receiver capable of receiving a digital broadcast signal having data of universal standard time and an intrinsic ID number of a broadcast station, the digital broadcast receiver comprises a clock, ROM for storing the intrinsic ID number of the broadcast station and data of a time zone of said broadcast station, and an MPU for controlling the clock and the ROM, and the MPU reads data of a time zone of the broadcast station corresponding to the intrinsic ID number of the broadcast station receiving at the most ratio out of the ROM and adds the data of the universal standard time to the data of said time zone to calculate time of a place where the broadcast station receiving most is located and adjusts time of the clock to said calculated time.

As a result of this, time of the clock of the digital broadcast receiver can be adjusted automatically, and time and effort in which a user checks the time to adjust the clock can be saved.

Also, a digital broadcast receiver according to the invention is characterized in that in a digital broadcast receiver capable of receiving a digital broadcast signal having data of universal standard time and an intrinsic ID number of a broadcast station, the digital broadcast receiver comprises clock means, and storage means for storing the intrinsic ID number of the broadcast station and data of a time zone of said broadcast station, and data of a time zone of the broadcast station corresponding to the intrinsic ID number of the broadcast station in a received digital broadcast signal is read out of the storage means and time of a place where the broadcast station is located is calculated based on the data of said time zone and the data of the universal standard time and time of the clock means is adjusted to said calculated time.

As a result of this, time of the clock means of the digital broadcast receiver can be adjusted automatically, and time and effort in which a user checks the time to adjust the clock means can be saved.

Further, an adjustment of time of the clock means can be made based on the intrinsic ID number of the broadcast station receiving at the most ratio of the received digital broadcast signals.

In this manner, by using the ID number of the broadcast station with the largest ratio receiving even in the case that the digital broadcast receiver is at the middle point substantially among plural broadcast stations and digital broadcast signals are received from their plural broadcast stations, time of the clock means of the digital broadcast receiver can be adjusted automatically. Therefore, it is unnecessary for a user to check the time and adjust the clock means.

### BRIEF DESCRIPTION OF THE DRAWINGS

FIG. 1 is a block diagram showing a configuration of a digital broadcast receiver of the present invention;

FIG. 2 is a flowchart showing an operation of the digital broadcast receiver of the invention;

FIG. 3 is a diagram showing time zone values corresponding to intrinsic ID numbers of broadcast stations in the digital broadcast receiver of the invention; and

FIG. 4 is a flowchart showing an operation of the digital broadcast receiver of the invention.

### DETAILED DESCRIPTION OF THE PREFERRED EMBODIMENTS

Now, a description will be given in more detail of preferred embodiments of the invention with reference to the accompanying drawings.

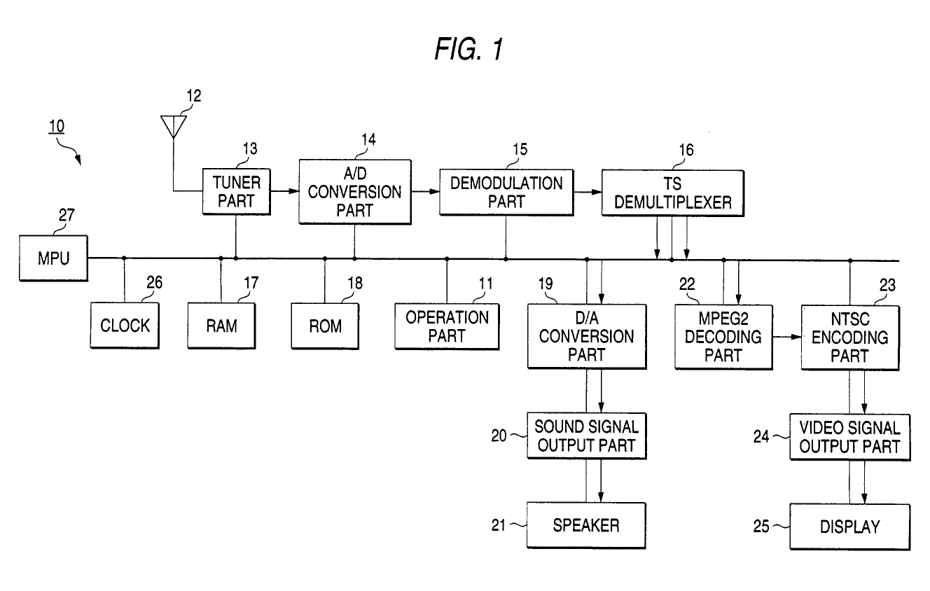

FIG. 1 is a block diagram showing a configuration of a digital broadcast receiver 10. Numeral 11 is an operation part in which a user performs an on-off operation of a power source or performs various operations such as a channel selection. Incidentally, the operation part 11 may be provided as remote control capable of remote operation. Numeral 12 is an antenna part for receiving digital broadcast waves, and numeral 13 is a tuner part for selecting a broadcast of a desired channel from the broadcast waves received by the antenna part 12, and numeral 14 is an A/D conversion part for converting an output wave from the tuner part 13 into a digital signal, and numeral 15 is a demodulation part for demodulating the output to data.

Also, numeral 16 is a TS demultiplexer for separating and outputting the data demodulated by the demodulation part 15 every kind, and numeral 17 is RAM for storing the separated data, and numeral 18 is ROM for storing information necessary for an operation of the digital broadcast receiver 10 including data of an intrinsic ID number of a broadcast station or a time zone of a broadcast station. Numeral 19 is a D/A conversion part for converting sound data of the data stored in the RAM 17 into analog, and numeral 20 is a sound signal output part for outputting the sound data converted into analog by the D/A conversion part 19, and numeral 21 is a speaker for issuing sound.

Also, numeral 22 is an MPEG2 decoding part for decoding video data of the data stored in the RAM 17 into video data before compression, and numeral 23 is an NTSC encoding part for decoding the decoded video data into an NTSC decoding television signal, and numeral 24 is a video signal output part for outputting the NTSC decoding television signal, and numeral 25 is a display for displaying video.

Also, numeral 26 is a clock capable of adjusting the present time based on a digital broadcast signal. Then, numeral 27 is an MPU for controlling an operation of the digital broadcast receiver 10.

Next, an operation at the time when the digital broadcast receiver 10 receives a broadcast will be described. Digital broadcast waves sent are first received by the antenna part 12. When the operation part 11 operates a channel selection, the tuner part 13 performs switching of a transponder received. The received digital broadcast waves are digitized by the A/D conversion part 14 and data is demodulated by the demodulation part 15.

Originally, a digital signal is sent from the sending side in a form of a TS (Transport Stream) packet. The TS packet comprises control data including video data, sound data, data of universal standard time, data in which an intrinsic ID number of a broadcast station is written, etc. and this control data is separated and outputted by the TS demultiplexer 16 and is stored in the RAM 17. Then, sound data read from the RAM 17 is converted into analog by the D/A conversion part 19, and sound is issued from the speaker 21 through the sound signal output part 20.

Also, video data read from the RAM 17 is decoded into video data before compression by the MPEG2 (Motion Picture Experts Group) decoding part 22 and is decoded into an NTSC decoding television signal by the NTSC encoding part 23 and video is displayed on the display 25 through the video signal output part 24.

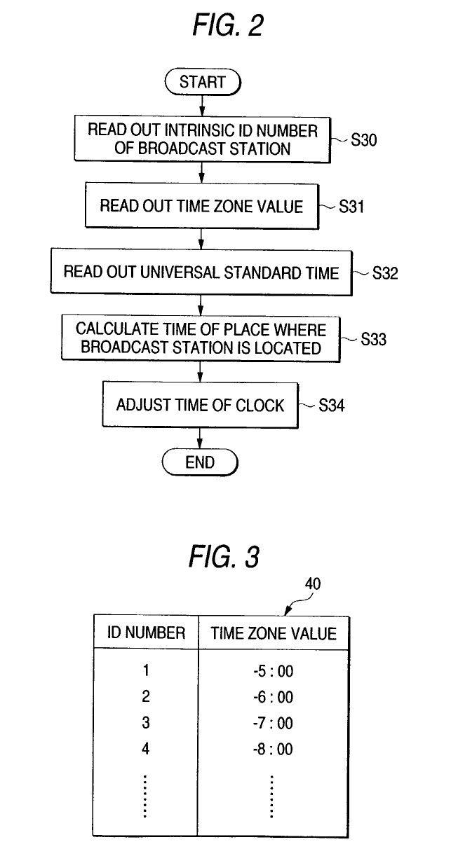

Next, an operation of the digital broadcast receiver 10 at the time of automatically adjusting time of the clock 26 will be described. A flowchart of an operation of the digital broadcast receiver 10 is shown in FIG. 2. In step S30, the digital broadcast receiver 10 on reception of a digital broadcast reads an intrinsic ID number of a broadcast station out of the RAM 17 in which the received TS packet is separated and stored every data. The operation proceeds to step S31 and a time zone value corresponding to the read ID number is read out using a correspondence table 40 of FIG. 3 previously stored in the ROM 18.

The operation proceeds from step S31 to step S32 and universal standard time is read out of the RAM 17, and the operation proceeds to step S33 and the read time zone value is added to the universal standard time to calculate time of a place where a broadcast station is located. Then, the operation proceeds to step S34 and time of the clock 26 is adjusted to the time calculated in step S33.

For example, when the digital broadcast receiver 10 is installed in Florida State of America, the digital broadcast receiver 10 receives a broadcast from a broadcast station of Florida State, and reads an intrinsic ID number of the broadcast station out of a received TS packet. Here, when an ID number of the broadcast station of Florida State is ID=1, the correspondence table 40 of FIG. 3 stored in the ROM 18 is retrieved to read out a time zone value (−5:00) corresponding to the ID=1. Then, the present universal standard time is read out of the TS packet and, for example, when the present time is 9:00, the time zone value (−5:00) is added to the universal standard time to calculate time of Florida State as 4:00 and the clock 26 is adjusted to 4:00.

In this manner, by using the received digital broadcast signal, time of the clock 26 of the digital broadcast receiver 10 can be adjusted automatically.

Therefore, it is unnecessary for a user to check the time and adjust the clock.

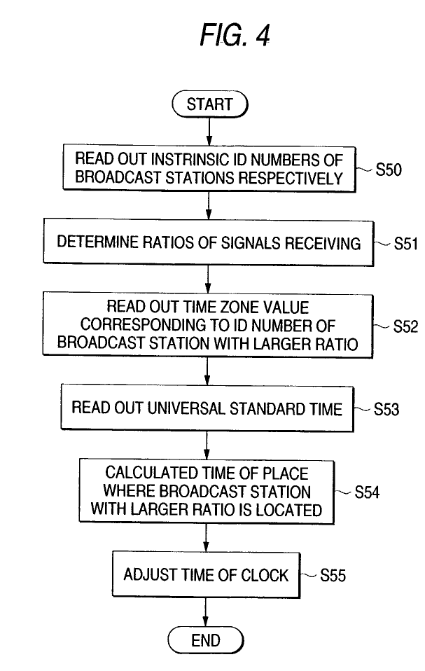

Next, an operation of the digital broadcast receiver 10 at the time of automatically adjusting time of the clock 26 in the case that the digital broadcast receiver 10 is installed at the middle point of two different broadcast stations and digital broadcast signals are simultaneously received from their two broadcast stations will be described. A flowchart of an operation of the digital broadcast receiver 10 is shown in FIG. 4.

In step S50, the digital broadcast receiver 10 on reception of a digital broadcast reads an intrinsic ID number of a broadcast station out of the RAM 17 in which the received TS packet is separated and stored every data. Here, two ID numbers are read out since broadcasts from two broadcast stations are received. Then, the operation proceeds to step S51 and it is determined which ratios receiving signals of the broadcast stations are larger, and the operation proceeds to step S52 and a time zone value corresponding to the ID number of the broadcast station with the larger ratio receiving is read out of the correspondence table 40 of FIG. 3.

The operation proceeds from step S52 to step S53 and universal standard time is read out of the RAM 17, and the operation proceeds to step S54 and the read time zone value is added to the universal standard time to calculate time of a place where a broadcast station with the larger ratio receiving is located. Then, the operation proceeds to step S55 and time of the clock 26 is adjusted to the time calculated in step S54.

For example, when the digital broadcast receiver 10 is installed at a point C of the side of California State between a broadcast station A of California State of America and a broadcast station B of Arizona State, the digital broadcast receiver 10 receives broadcasts from both of the broadcast station A and the broadcast station B, and reads intrinsic ID numbers of the broadcast stations out of received TS packets. Here, when the ID number of the broadcast station A is ID=4 and when the ID number of the broadcast station B is ID=3, their two ID numbers are read out and it is determined which ratios receiving signals of the broadcast stations are larger.

Now, the point C is in the side of California State and the ratio receiving the signal of the broadcast station A is larger, so that the correspondence table 40 of FIG. 3 stored in the ROM 18 is retrieved to read out a time zone value (−8:00) corresponding to the ID=4 of the broadcast station A. Then, the present universal standard time is read out of the TS packet and, for example, when the present time is 9:00, the time zone value (−8:00) is added to the universal standard time to calculate time of California State as 1:00 and the clock 26 is adjusted to 1:00.

In this manner, by using the ID number of the broadcast station with the larger ratio receiving even in the case of receiving the digital broadcast signals from the two broadcast stations, time of the clock 26 of the digital broadcast receiver 10 can be adjusted automatically. Therefore, it is unnecessary for a user to check the time and adjust the clock.

Incidentally, an adjustment of the time of the clock 26 may be made in the case that a time adjusting button (not shown) is provided in the operation part 11 and the time adjusting button is pushed down, or may be made in the case of turning on a power source or periodically every predetermined time. The time of the clock 26 can be accurately maintained always by making time adjustments frequently.

Incidentally, in the embodiment described above, a-digital television in which the digital broadcast receiver 10 is integrated with the speaker 21 and the display 25 has been described, but it may be a digital broadcast receiver such as a digital broadcast tuner or a video device without the speaker 21 and the display 25.

Also, it may be applied to a wristwatch or a table clock.

According to a digital broadcast receiver of the invention, by reading data of a time zone of a broadcast station out of storage means based on an intrinsic ID number of the broadcast station in a received digital broadcast signal and calculating time of a place where the broadcast station is located based on the data of the time zone and the data of the universal standard time and adjusting time of the clock means to this calculated value, time of the clock means can be adjusted automatically, and time and effort in which a user checks the time to adjust the clock means can be saved.

Also, according to a digital broadcast receiver of the invention, by making an adjustment of time of the clock means based on the intrinsic ID number of the broadcast station receiving at the most ratio of the received digital broadcast signals, even in the case that the digital broadcast receiver is at the middle point substantially among plural broadcast stations and digital broadcast signals are received from their plural broadcast stations, the ID number of the broadcast station with the largest ratio receiving is used and time of the clock means can be adjusted automatically. Therefore, it is unnecessary for a user to check the time and adjust the clock means.

What is claimed is:

1. A digital broadcast receiver capable of receiving a digital broadcast signal having data of universal standard time and an intrinsic ID number of a broadcast station, comprising:
a clock;
a ROM for storing the intrinsic ID number of the broadcast station and data of a time zone of said broadcast station; and
an MPU for controlling the clock and the ROM, wherein the MPU reads data of a time zone of the broadcast station corresponding to the intrinsic ID number of the broadcast station receiving at the most ratio out of the ROM and adds the data of the universal standard time to the data of said time zone to calculate time of a place where the broadcast station receiving most is located and adjusts time of the clock to said calculated time.

2. A digital broadcast receiver capable of receiving a digital broadcast signal having data of universal standard time and an intrinsic ID number of a broadcast station, comprising:
clock means; and
storage means for storing the intrinsic ID number of the broadcast station and data of a time zone of said broadcast station, wherein data of a time zone of the broadcast station corresponding to the intrinsic ID number of the broadcast station in a received digital broadcast signal is read out of the storage means and time of a place where the broadcast station is located is calculated based on the data of said time zone and the data of the universal standard time and time of the clock means is adjusted to said calculated time.

3. The digital broadcast receiver as defined in claim 2, wherein an adjustment of time of the clock means is made based on the intrinsic ID number of the broadcast station receiving at the most ratio of the received digital broadcast signals.
